(19) United States
(12) Patent Application Publication
(10) Pub. No.: US 2010/0171971 A1
(43) Pub. Date: Jul. 8, 2010

(54) PRINTING APPARATUS, COLOR CORRECTING METHOD, AND PROGRAM

(75) Inventor: Jun Hoshii, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/648,473

(22) Filed: Dec. 29, 2009

(30) Foreign Application Priority Data
Jan. 8, 2009 (JP) 2009-002242

(51) Int. Cl. H04N 1/60

(52) U.S. Cl. 358/1.9; 358/406

(57) ABSTRACT

A printing apparatus which executes a calibration operation of matching a measured value of a color reproduced on a print medium with a target value of the color. The printing apparatus includes a unit which executes the calibration operation only on restricted patches satisfying a predetermined condition without executing the calibration operation on all of the patches, when the print medium is exchanged or a print color material is exchanged.

### BACKGROUND

1. Technical Field

The present invention relates to a printing apparatus, a color correcting method, and a program.

2. Related Art

The hue or concentration of colors to be printed is different in every printing apparatus, since there is a difference in every printing apparatus. For this reason, at the shipment of a printing apparatus, a correction value for the characteristic of the printing apparatus is determined so that an image to be formed in effect in a medium (print medium) has a predetermined standard value (hereinafter, referred to as a target value). Therefore, when an image is formed, a color correcting process is executed on image data as a target on the basis of the correction value.

With environmental change or secular change, however, the above-described characteristics are also varied. For this reason, in order to maintain an output result with the target value, it is necessary for a printing apparatus to appropriately execute a color correction calibration operation of correcting the original correction value.

As one method of the calibration operation, a color chart can be used. In this method, a color chart, which is made from a plurality of patch patterns formed by varying gray scales of image data for each color of a color material (toner or ink) used in a printing apparatus, is printed. A process of updating the target value so that a printed image has the target value is executed by measuring the color value of each patch pattern of the color chart by use of a measurement device and updating the correction value on the basis of the difference between a predicted target value and a measured value for the gray scale value of each patch pattern. On the basis of the updated value, a lookup table (LUT) is appropriately updated.

A printing process of the patch pattern of the calibration operation and a method of creating the correction value are disclosed in JP-A-2000-246923.

In the printing apparatus, however, the color in a printing process is varied due to change in external factors as well as temperature change or secular change. For example, when a sheet serving as a print medium is changed or when an ink cartridge serving as a color material is exchanged, a printed color value may be varied minutely. This is because the color of a sheet is changed and the printed color is varied even though an amount of ink is controlled in the printing process so as to maintain the same ink concentration (gray-scale gradient). Moreover, in some cases, the colors of ink cartridges may not be identical with each other due to different manufacturing time or lot. Therefore, when the ink cartridge is exchanged, the printed colors may be changed minutely.

In this case, it is necessary to adjust the correction value again so as to approach the target value, by executing the calibration operation.

In this case, however, when the calibration operation is forcibly executed, all patches of a system are subjected to the calibration operation. Therefore, it is necessary to execute the calibration operation for a long time. Moreover, since ink of all colors is used to execute the calibration operation, a large amount of ink may be consumed.

### SUMMARY

An advantage of some aspects of the invention is that it provides a technique capable of reducing the consumables such as ink, for example, by executing a calibration operation for a short time.

According to an aspect of the invention, there is provided a printing apparatus which executes a calibration operation of matching a measured value of a color reproduced on a print medium with a target value of the color. The printing apparatus includes a unit which executes the calibration operation only on restricted patches satisfying a predetermined condition without executing the calibration operation on all of the patches, when the print medium is exchanged or a print color material is exchanged.

Since calibration target colors are restricted and the calibration operation is executed, it is possible to shorten a period during which the calibration operation is executed. Moreover, since ink of all color is not used and only ink of changed colors is used, it is possible to reduce the use amount of consumables.

The printing apparatus may further include a unit which determines whether ink, which is the print color material, before the exchange is exhausted during a printing process, when the ink is exchanged; and a unit which discharges remaining ink before the exchange when it is determined that the ink is exhausted, prints a new check pattern, and executes the calibration operation when a color difference is equal to or larger than a predetermined threshold.

In a case where the amount of remaining ink is calculated when ink is exchanged and the ink of remaining ink is discharged when the remaining ink is exhausted during a predetermined printing process, the calibration operation is executed when the color difference of new ink is equal to or larger than the predetermined threshold. Accordingly, it is possible to shorten the period during which the calibration operation is executed. Moreover, it is possible to prevent a printed color from being changed during the printing process.

The printing apparatus may further include a unit which acquires information used to identify a characteristic of the exchanged print color material and determines whether the calibration operation is executed.

Since information on the color can be acquired from the information recorded in the print color material such as an ink cartridge, for example, from a memory chip of the ink cartridge, it is possible to know that the color is changed. Accordingly, it is possible to determine the necessity for executing the calibration operation.

The printing apparatus may further include a unit which prints a check pattern and execute the calibration operation on a color, in which a color difference is equal to or larger than the predetermined threshold, when the print medium is exchanged.

Since the calibration operation is executed on the color in which the color difference is equal to or larger than the predetermined threshold by measuring the color in the printed state of the exchanged print medium, it is possible to reduce the amount of consumables used in the printing process and the period during the calibration operation is executed.

According to another aspect of the invention, there is provided a color correcting method of executing a calibration operation of matching a measured value of a color reproduced on a print medium with a target value of the color. The color correcting method includes executing the calibration operation only on restricted patches satisfying a predetermined condition without executing the calibration operation on all of the patches, when the print medium is exchanged or a print color material is exchanged.

According to still another aspect of the invention, there is provided a program which is installed in a computer and causes the computer to operates as a printing apparatus which executes a calibration operation of matching a measured value of a color reproduced on a print medium with a target value of the color and which includes a unit executing the calibration operation only on restricted patches satisfying a predetermined condition without executing the calibration operation on all of the patches, when a print sheet is exchanged or a print color material is exchanged. The program can be installed in the computer through a storage medium or a communication line.

According to the above aspects of the invention, it is possible to execute the calibration operation in a short time. Moreover, it is possible to reduce the consumption of consumables in the calibration operation.

### BRIEF DESCRIPTION OF THE DRAWINGS

The invention will be described with reference to the accompanying drawings, wherein like numbers reference like elements.

FIG. 1 is a block diagram illustrating exemplary configurations of a PC and a printer of a printing apparatus according to an embodiment of the invention.

FIG. 2 is a flowchart illustrating a calibration operation when an ink cartridge used in the printing apparatus in FIG. 1 is exchanged.

FIG. 3 is a flowchart illustrating the calibration operation when a medium used in the printing apparatus in FIG. 1 is exchanged.

FIG. 4 is a diagram illustrating an example where a plurality of PCs uses one printer according to a modified example of the invention.

### DESCRIPTION OF EXEMPLARY EMBODIMENTS

Hereinafter, an embodiment of the invention will be described with reference to the accompanying drawings. The same reference numerals in the drawings are given to the same constituent elements and the repeated description is omitted.

### Configuration of PC

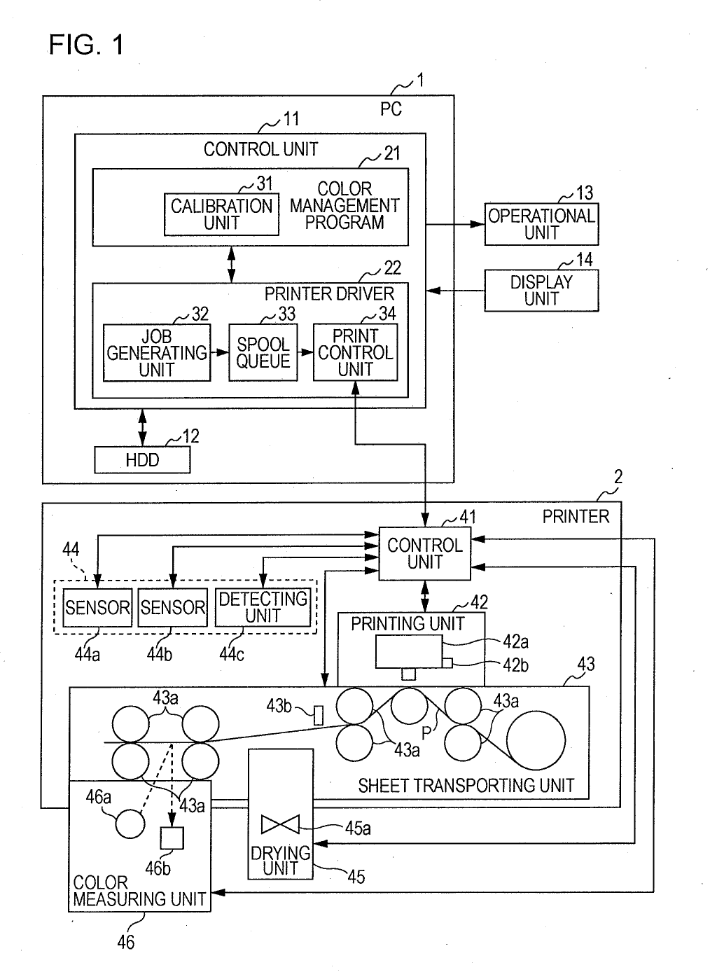

FIG. 1 is a block diagram illustrating exemplary configurations of a PC 1 and a printer 2 according to an embodiment. The PC 1 and the printer 2 constitute a printing apparatus.

The PC 1 generates print data expressed by formation or non-formation of color dots printed by the printer 2 from color image data expressed by color gray scales of RGB such as an object designated by a user. The PC 1 supplies the generated print data to the printer 2. The printer 2 is a color ink jet printer capable of executing a so-called direct printing process of printing an image, which is based on the print data supplied from the PC 1, on a fed sheet at a plurality of resolutions. The PC 1 executes a calibration operation, which is described below, in cooperation with the printer 2.

The PC 1 includes a control unit 11 and a hard disk drive (HDD) 12. The PC 1 is operated through an operational unit 13 constituted by a keyboard, a pointing device, or the like or a display unit 14 constituted by a dot matrix display or the like.

The control unit 11 includes a RAM (Random Access Memory), a CPU (Central Processing Unit), and an I/O (all of which are not shown). The control unit 11 causes the printer 2 to print the object designated by the user or executes the calibration operation in cooperation with the printer 2 by executing a computer program stored and maintained in the hard disk drive 12, for example.

The hard disk drive 12 records a variety of computer programs such as an operation system (not shown), a color management program 21, and a printer driver 22. The hard disk drive 12 stores and maintains correction values used for a color correcting process. Since the correction values used in the color correcting process are different from each other depending on a print medium (that is, medium) and a resolution, the correction values are stored and maintained in a file format for every medium and resolution.

The color management program 21 is an application program which supplies functions such as a printing process of a object, a printing process of a color chart, a color measuring process of a color chart, a color correcting process, and a printing authentication process. The printer driver 22 is an application which controls the printer 2 under the control of the color management program 21 and executes the printing process.

When the color management program 21 is executed by the control unit 11, the color management program 21 execute controlling as a calibration unit 31. The color management program is operated as a job generating unit 32, a spool queue 33, and a print control unit 34, when the color management program is executed by the printer driver 22 in the control unit 11.

### Configuration of Printer

The printer 2 includes a control unit 41, a printing unit 42, a sheet transporting unit 43, a sensor group 44, a drying unit 45, and a color measuring unit 46.

The control unit 41 includes a RAM, a ROM (Read-Only Memory), a CPU, and an I/O (all of which are not shown). The control unit 41 controls each unit to execute a printing process or the like by controlling each unit in response to an instruction from the PC 1.

The printing unit 42 includes a printing head 42a, a driving mechanism moving the printing head 42a in a direction perpendicular to a transport direction of a sheet (a sheet P in an example of FIG. 1) serving as a print medium, and a motor (all of which are not shown). The printing unit 42 forms an image of a print object on the sheet P in an ink jet manner under the control of the control unit 41. The printing head 42a is provided with a temperature sensor 42b measuring the temperature of the printing head 42a.

The sheet transporting unit 43 includes a plurality of rollers 43a transporting the sheet P, a motor (not shown), and a cutter 43b cutting the print sheet P. The sheet transporting unit 43 transports the sheet P and cuts the sheet P simultaneously under the control of the control unit 41.

A temperature sensor 44a and a humidity sensor 44b, which constitute the sensor group 44, detecting temperature and humidity, respectively, and a detecting unit 44c detecting variation in a use condition of the printer 2 are installed in the case of the printer 2.

For example, when an ink cartridge (not shown) is exchanged, the detecting unit 44c detects the exchange of the ink cartridge and transmits a signal indicating the exchange of the ink cartridge to the control unit 41. The control unit 41 delivers the detection signal transmitted from the detecting unit 44c to the PC 1. The calibration unit 31 of the PC 1 acquires the detection signal through the print control unit 34. The calibration unit 31 executes a flow used to determine whether to execute the calibration operation, when the calibration unit 31 acquires the detection signal.

When a new medium is loaded in the printer 2, the detection unit 44c detects the loading of the new medium, specifies the loaded medium, and transmits information (for example, an ID) used to identify the medium to the control unit 41. Specifically, when a roll sheet is loaded in a roll mounting unit (not shown), the detecting unit 44c transmits the ID of the medium, which is obtained by reading the barcode attached on the roll sheet, to the control unit 41. When the information used to identify the medium cannot be obtained, the color measuring unit 46 may determine the color of the medium and determine whether the medium is a target for the calibration operation in order to determine whether the calibration operation is executed.

The drying unit 45 includes a wind blowing fan 45a and a heater (not shown). The drying unit 45 dries the sheet P transmitted by the sheet transporting unit 43 of the printer 2 under the control of the control unit 41 of the printer 2.

The color measuring unit 46 includes a light source 46a, a spectroscope (not shown), and a light receiving unit 46b. Under the control of the control unit 41 of the printer 2, the color measuring unit 46 measures a Lab value for a check pattern or each patch pattern of a color chart printed on the sheet P transported by the sheet transporting unit 43 of the printer 2 in accordance with a spectrophotometric colorimetry. The measurement is executed when a color difference between the check patterns used upon determining whether the calibration operation is executed is determined and when the correction value is obtained by executing the calibration operation.

In FIG. 1, the functional configuration of the control unit 11 of the PC 1 executing the calibration operation is shown. This function can be realized by causing the control unit 11 to execute the color management program 21 and the printer driver 22 stored in the hard disk drive 12.

The calibration unit 31 is realized by executing the color management program 21. The calibration unit 31 controls the printer driver 22 and controls the execution of the calibration operation.

The job generating unit 32, the spool queue 33, and the print control unit 34 are realized by executing the printer driver 22, as described above.

The job generating unit 32 generates a print job for printing an arbitrary object designated by the user or generates a print job for printing a color chart used for the calibration operation or a print job for printing authentication information under the control of the calibration unit 31.

Here, the authentication information is information which is used to authenticate the print status or state of the color chart used for the calibration operation. The authentication information is constituted by time at which the printing process is executed, temperature or humidity at which the printing process is executed, and a character, a sign, or the like indicating the temperature of the printing head 42a when the printing is executed.

The spool queue 33 forms a buffer which temporarily stores the job generated by the job generating unit 32.

The print control unit 34 sequentially selects and executes the jobs stored in the spool queue 33. That is, the print control unit 34 controls the printer 2 by transmitting a command forming the job to the printer 2 and causes the printer 2 to print the object, the color chart, or the authentication information set in the job.

The drying unit 45 and the color measuring unit 46 input an instruction of the dryness and color measurement through the control unit 41 of the printer 2, respectively, and execute the drying and the color measurement on a printed image containing the check pattern for determining whether to execute the calibration operation or the color chart for the calibration operation. Specifically, the drying unit 45 activates the heater and the wind blowing fan 45a and dries the entire ink forming the check pattern or the color chart while transporting the sheet P.

The color measuring unit 46 measures each color patch pattern organizing the check pattern or the color chart by lighting the light source 46a, illuminating the color chart, and detecting light incident on the light receiving unit 46b through the spectroscope and reflected from the check pattern or the color chart. At this time, the control unit 41 transports the sheet P to the location where the check pattern or the color chart is dried by the drying unit 45 and transports the sheet P for the operation of the color measuring unit 46 after the dryness, by controlling the sheet transporting unit 43.

When the image of the check pattern or the color chart is dried and the color of the image is measured, the color measuring unit 46 transmits the color measurement result to the PC 1 through the control unit 41 of the printer 21. The color measurement result is image data made by reading the patch pattern organizing the check pattern or the color chart at the Lab value.

Calibration Operation when Ink Cartridge IS Exchanged

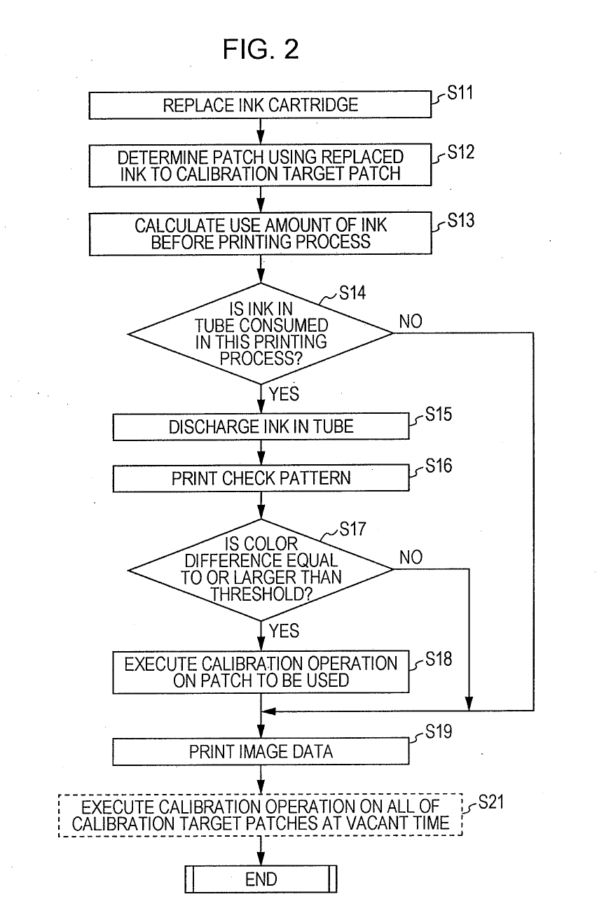

Next, the calibration operation executed when the ink cartridge serving as a print color material is exchanged will be described with reference to FIG. 2. FIG. 2 is a flowchart illustrating an operation executed when the ink cartridge is exchanged.

When the signal indicating the exchange of the ink cartridge is transmitted from the detecting unit 44c to the control unit 41 of the printer 2, the control unit 41 delivers information indicating the exchange of the ink cartridge to the print control unit 34 of the PC 1. The calibration unit 31 starts the calibration operation shown in FIG. 2 in response to the delivery of the information to the print control unit 34 (step S11).

First, when a cyan ink cartridge is exchanged, for example, a patch (calibration color sample) used for cyan ink is set to a calibration target patch (step S12). At this time, only the patch used for the exchanged cyan ink is the calibration target patch among calibration target patch patterns and the patches for the other color ink are not the calibration target patch. In this way, it is possible to reduce the amount of used ink which is not exchanged when the calibration operation is executed. Moreover, since the printed patch is reduced, the color measuring target patch is also reduced. Therefore, it is possible to shorten a time during which the calibration operation is executed.

The amount of ink to be used upon printing the image data in a print command is calculated (step S13). At this time, the amount of ink necessary when the image data from a customer or the like is printed on the sheet P by the printer 2 is calculated. Since the use amount of each ink can be known from the image data, that is, the print shape, the amount of each color ink can be calculated every one-time printing process.

When the ink cartridge is exchanged, it is determined whether the ink in a tube formed from the exchanged ink cartridge to the printing head 42a is consumed up (step S14). The reason for executing this determination is because the tube formed from the ink cartridge to the printing head 42a is long in the printer 2 executing the printing process on the sheet P, a certain amount of ink remains in the tube before the exchange, and thus the printing process ends using the ink remaining in the tube before the exchange.

When the printing process ends using the ink remaining in the tube before the exchange and thus it is determined that the remaining ink is not consumed up (No in step S14), the image data given as a job is just printed, and then the printing process ends (step S19). When the printing process ends and then a subsequent printing process is executed, the process returns to step S13.

When it is determined that the ink remaining in the tube formed from the ink cartridge to the printing head 42a before the exchange is consumed up, the ink in the tube is discharged (step S15). The ink is discharged by a mechanism which sucks and discharges the remaining ink.

After the ink in the tube is discharged in step S15, the check pattern used to make a comparison with the target value is printed (step S16). The check pattern is printed by using only the exchanged ink. By measuring the color of the printed check pattern and making a comparison with the target value, it is determined whether the difference (color difference) between the colors is equal to or larger than a predetermined threshold (step S17). When the color difference does not reach the predetermined threshold, the image data given as the job is printed without executing the calibration operation in step S19. Alternatively, in executing the determination of step S17, it may be determined whether the color difference exceeds the predetermined threshold.

When the color difference obtained by comparing the check pattern to the target value exceeds the predetermined threshold, the calibration operation is executed on the patch (color) which is used in this printing process (step S18). The calibration operation is executed only on the patch of the color (which is the calibration target patch of the color in step S12) of the exchanged ink cartridge and the patch which is used in this printing process. For example, when the cyan ink cartridge is exchanged, the patch is used for “the cyan”. Only the color which is used for the printing process is printed as a color chart, the patch becomes a comparison target, and the correction value is created by the calibration operation. The lookup table in the hard disk drive 12 is updated by the created correction value.

Subsequently, the image data give as the job is printed on the basis of the correction value obtained in the calibration operation (step S19).

In the flowchart shown in FIG. 2, step S21 may be executed. In step S21, the calibration operation is executed on all of the calibration target patches in vacant time. In this case, when the color difference is equal to or larger than the predetermined threshold in step S17, the calibration operation, which is executed on the patch which is not the target patch in step S18 and on the patch which is not the use target and is the use target in step S18, may be executed at any time during vacant time of the user. In this way, when the ink cartridge is exchanged, the calibration operation is executed on the patches using the exchanged ink and all of the patches of which the color difference is equal to or larger than the predetermined threshold.

When the ink cartridge is exchanged, whether the calibration operation is necessary is determined and the calibration operation is executed only on the patch of the exchanged color, and it is not necessary to execute the calibration operation on other color. Accordingly, it is possible to reduce the use amount of ink, which is used as consumables used in the calibration operation. Moreover, since the number of patches of the color chart used upon executing the calibration operation is reduced, it is possible to shorten a period during which the calibration operation is executed.

Calibration Operation when Medium is Exchanged

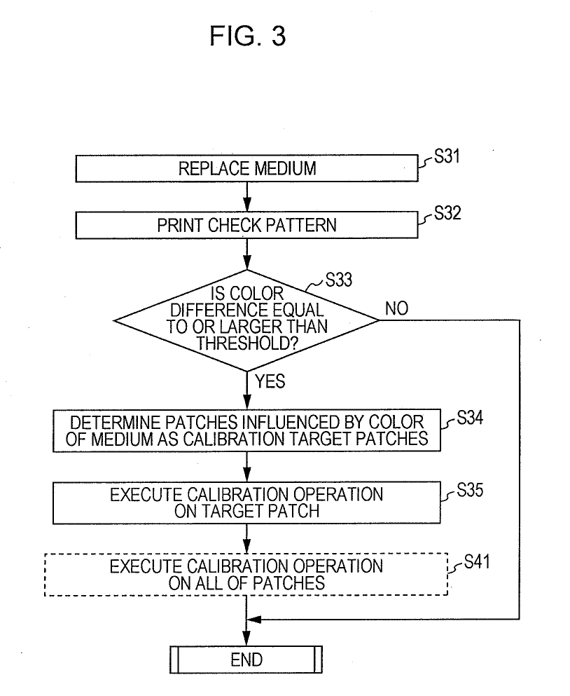

Next, the calibration operation executed when the medium (the sheet P) serving as a print medium is exchanged will be described with reference to a flowchart in FIG. 3.

The control unit 41 detects that the medium is exchanged, by using a signal from the detecting unit 44c (step S31). Subsequently, the control unit 41 executes a calibration check pattern printing process (step S32). This printing process is executed for all colors (patches).

By comparing the printed check pattern and the target value, it is determined whether the color difference is equal to or larger than the predetermined threshold (step S33). When the color difference is equal to or larger than the predetermined threshold, the calibration operation is executed. At this time, the patches to be subjected to the calibration operation are patches influenced by the color the medium (the sheet P) and these patches are determined as the calibration target patches (step S34). In determining the calibration target patches, a method of determining faint colors as the calibration target patches or a method of excluding colors with a large amount of ink may be used. This is because there is a high possibility that the color of the sheet is easily seen with the faint colors and this is because the colors with a large amount of ink are rarely influenced by the medium. In this way, the calibration operation executed only on the patches of the colors influenced from the color of the sheet P is executed (step S35). Alternatively, when the calibration target patch is specified, the patch of which the color difference is equal to or larger than a predetermined threshold may be determined as the calibration target patch or the patch of which the color difference is a predetermined multiple of the predetermined threshold may be determined as the calibration target patch.

The fact that the calibration target patch is specified to execute the calibration operation means that only the patch of the color changed due to the color of the sheet P is printed to execute the calibration operation, like the case where the ink cartridge is exchanged. Information on the color of the sheet P may be acquired by causing the detecting unit 44 to read the ID attached on a roll sheet, when the sheet is the roll sheet, for example. Alternatively, the numeral, the identity sign, or the like of the sheet P may be input through the operational unit 13 by an operator. Alternatively, the information on the color of the sheet P may be acquired by the color measuring unit 46. Based on the acquired information on the color of the sheet P, the degree of the influence of the basic color of the sheet P and the color can be specified, even though the printing process of the check pattern in step S32 and the determination in step S33 are not executed. Therefore, whether to execute the calibration operation may be omitted. Since the target color is specified, only the patch pattern of the specified color is printed to execute the calibration operation. Even in this case, the calibration operation is not executed on all of the colors.

At vacant time, the calibration operation may be executed on all of the patches (step S41). This calibration operation is arbitrarily executed at any time and may not be contained in the flow which is forcibly executed after the determining whether to execute the calibration operation executed when the medium is exchanged. The step in which the calibration operation is executed on all of the patches may be contained in the flow shown in FIG. 2.

### OTHER EMBODIMENTS

In the above-described embodiment, when the ink cartridge is exchanged, the check pattern is first printed using the exchanged ink and the printed check pattern (the color chart) is compared to the target value. However, information identifying an ink cartridge, such as an identity number, a date, or the like of each lot, is given or recorded in the ink cartridge. In many cases, this information is stored in the chip memory of the ink cartridge. When the information on the color of the exchanged ink is acquired from the information given or recorded in the ink cartridge and the degree of the color difference with the target value is known, the calibration operation can be executed without comparing the check pattern and determining whether the color difference is equal to or larger than the predetermined threshold. In this case, when the ink cartridge is exchanged, it is preferable that the details of the chip memory are automatically read by the control unit 41 of the printer 2. In addition, it is preferable that database of the information on the color in each lot of the ink cartridge exists in the hard disk drive 12 or in a place (not shown) which can be accessed through a communication line.

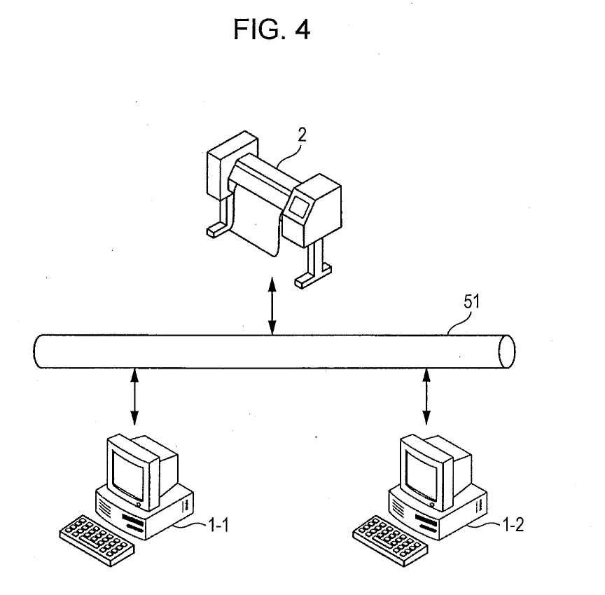

When the PC 1 and the printer 2 are used, the PC and the printer can be used in a one-to-one use manner in FIG. 1 or a plurality of the PCs 1 can use one printer 2. For example, when the printer 2 is a printing apparatus capable of printing several copy images in succession at high speed, the plurality of PCs can use the printer. FIG. 4 shows that two PCs 1-1 and 1-2 use one printer 2 in a use environment where the two PCs 1-1 and 1-2 are connected to one printer 2 through a network 51.

When the plurality of PCs 1 exist, the PC 1-1 and the PC 1-2 are used and the calibration operation is executed and it is assumed that the PC 1-2 has data necessary in the PC 1-1, for example. That is, it is assumed that the PC 1-2 stores and maintains a file of the correction value for a predetermined medium, which is necessary in the PC 1-1. At this time, when the PC 1-2 has the file of the correction value necessary in the PC 1-1, it is not necessary to execute the calibration operation to obtain the file of the correction value, and the file of the correction value is acquired from the PC 1-2 so that the PC 1-1 executes the color correction by use of the acquired file. In this case, the printing apparatus may be constituted by the PC 1-1 and the printer 2 or by the PC 1-2 and the printer 2.

In the above-described embodiment, the calibration operation executed when the image is printed by the printer 2 executing the printing process on the broad sheet surface of the roll sheet (the sheet P) has been described. However, the same can be applied to a printer which includes a color measuring unit executing the calibration operation and prints a single sheet. In the above-described embodiment, one printing apparatus executes the flow shown in FIG. 2 and the flow shown in FIG. 3. However, printing apparatus may execute only one of the flows may be executed. Alternatively, the printing apparatus may realize one or both of the above-described embodiments.

The color management program 21 and/or the printer driver 22 executing the calibration operation may be recorded as a program in a recording medium or may be installed in the PC 1, PC 1-1, and the PC 1-2 through a communication line.

The above-described functions of the PC 1 may be embedded in the printer 2 and the printer 2 may serve as a printing apparatus. One function of the printer 2, for example, one function of the control unit 41 may be embedded in another unit of the PC 1 or the like.

The disclosure of Japanese Patent Application No. 2009-002242 filed Jan. 8, 2009 including specification, drawings and claims is incorporated herein by reference in its entirety.

What is claimed is:

1. A printing apparatus which executes a calibration operation of matching a measured value of a color reproduced on a print medium with a target value of the color, the printing apparatus comprising a unit which executes the calibration operation only on restricted patches satisfying a predetermined condition without executing the calibration operation on all of the patches, when the print medium is exchanged or a print color material is exchanged.

2. The printing apparatus according to claim 1, further comprising:
a unit which determines whether ink, which is the print color material, before the exchange is exhausted during a printing process, when the ink is exchanged; and
a unit which discharges remaining ink before the exchange when it is determined that the ink is exhausted, prints a new check pattern, and executes the calibration operation when a color difference is equal to or larger than a predetermined threshold.

3. The printing apparatus according to claim 1, further comprising a unit which acquires information used to identify a characteristic of the exchanged print color material and determines whether the calibration operation is executed.

4. The printing apparatus according to claim 1, further comprising a unit which prints a check pattern and execute the calibration operation on a color, in which a color difference is equal to or larger than the predetermined threshold, when the print medium is exchanged.

5. A color correcting method of executing a calibration operation of matching a measured value of a color reproduced on a print medium with a target value of the color, the color correcting method comprising executing the calibration operation only on restricted patches satisfying a predetermined condition without executing the calibration operation on all of the patches, when the print medium is exchanged or a print color material is exchanged.

6. The color correcting method according to claim 5, further comprising:
determining whether ink, which is the print color material, before the exchange is exhausted during a printing process, when the ink is exchanged; and
discharging remaining ink before the exchange when it is determined that the ink is exhausted, printing a new check pattern, and executing the calibration operation when a color difference is equal to or larger than a predetermined threshold.

7. The color correcting method according to claim 5, further comprising acquiring information used to identify a characteristic of the exchanged print color material and determining whether the calibration operation is executed.

8. A program which is installed in a computer and causes the computer to execute the calibration operation according to claim 1.
